(19) United States
(12) Patent Application Publication
(10) Pub. No.: US 2022/0003441 A1
(43) Pub. Date: Jan. 6, 2022

(54) METHOD OF CONTROLLING AN AIR-CONDITIONING SYSTEM

(71) Applicant: De' Longhi Appliances S.r.l. con Unico Socio, Treviso (IT)

(72) Inventors: Enrica MONTICELLI, Treviso (IT); Roshanak Seyedem MIRMIRAN, Treviso (IT); Andrea GIOMO, Treviso (IT)

(21) Appl. No.: 17/293,237

(22) PCT Filed: Nov. 12, 2019
(86) PCT No.: PCT/IT2019/050242

§ 371 Date: May 12, 2021

(30) Foreign Application Priority Data
Nov. 13, 2018 (IT) 102018000010272

(51) Int. Cl. F24F 11/00; F24F 11/77; F24F 11/79

(52) U.S. Cl. CPC F24F 11/0001; F24F 2110/12; F24F 11/79; F24F 11/77

(57) ABSTRACT

A method is described to control a conditioning apparatus to prevent or reduce the risk or likelihood that molds will form, proliferate and grow, in particular in internal spaces conditioned by the conditioning apparatus. The control method provides to receive information that is characteristic of the room to be conditioned indicative of the thermal state of this room, to calculate a risk factor indicative of the likelihood of mold formation in the room to be conditioned, in which the risk factor is a function of the characteristic information, and to compare the risk factor with a respective threshold value, in which it is provided to activate the conditioning apparatus for a determinate interval of time when the outcome of the comparison of the risk factor calculated with the respective threshold value reveals a high risk of mold formation.

### FIELD OF THE INVENTION

The present invention concerns a method to control a conditioning apparatus to prevent or reduce the risk that molds will form and grow in the internal spaces of a building.

The invention also concerns a conditioning apparatus in which the control method as above is implemented.

### BACKGROUND OF THE INVENTION

Conditioning apparatuses are known in the state of the art which are used to regulate the environmental conditions of the internal spaces of a building.

In particular, these conditioning apparatuses are typically used to heat or cool or dehumidify the spaces as above.

The conditioning apparatuses known in the state of the art are directly driven by the user, for example by means of a remote control or a control panel on which it is possible to set the desired environmental temperature and/or relative humidity. In other solutions known in the state of the art, the apparatuses can be driven remotely from a portable electronic device, such as for example a smartphone, or from a fixed monitoring unit, for example mounted on one of the walls of the room to be conditioned.

Some types of conditioning apparatuses provide the possibility that a user can pre-set a “delayed” activation of the apparatuses themselves, so that they are activated at a determinate subsequent moment, for example at a certain pre-established time at which the user could also be absent.

It is also well known that, during use, while these conditioning apparatuses operate to bring the room to be conditioned to the parameters set by the user, they modify the temperature and/or the relative humidity of the room to be conditioned.

One disadvantage of the conditioning apparatuses known in the state of the art is that they have to be activated or programmed directly by the user.

This is disadvantageous because the user is not able to program the apparatus by setting the most suitable functioning parameters, as a function of the current external atmospheric conditions and/or of the current internal environmental conditions. An incorrect programming of the apparatus can lead in one case to the apparatus functioning for a period of time not sufficient to reduce the likelihood of mold forming, or—in the opposite case—to the apparatus functioning for an excessive amount of time, which determines an increase in electricity consumption, and the corresponding costs.

Another disadvantage of apparatuses of the known type occurs when, in the event the user is absent for an extended period of time, the conditioning apparatus remains inactive for a long time, and harmful environmental conditions can be generated in the room to be conditioned.

In particular, as far as the purposes of the present invention are concerned, the harmful environmental conditions referred to are those conditions that promote the formation and growth of molds in the room.

This is naturally undesirable because molds have a negative impact on people's health. In some cases, in fact, molds are able to trigger various types of infections of a bacterial nature in humans. Furthermore, molds damage the walls of the rooms because they damage the plaster, which will have to be restored after removing the mold from them.

For these reasons, the problem of the formation and spread of molds in the internal rooms of a building has been studied in great detail in the past in order to identify the conditions that promote the formation and spread of molds.

The studies conducted have demonstrated a direct correlation between the relative humidity values and the likelihood of molds forming.

It has been observed that high values of relative humidity promote the formation of molds. For example, during the winter season, particularly in countries where the cold season is particularly harsh, the formation of molds tends to occur in the proximity of the walls of the rooms to be conditioned which are generally at a lower temperature than in other zones of the room.

It is in fact known that molds require a substrate on which to proliferate, such as for example walls made of wood, walls covered with ceramic tiles, plasterboard walls, walls covered with wallpaper, carpets, furniture, etc. Then there are some internal rooms, such as the kitchen or bathroom, where—due to their intended use—the relative humidity is higher and the risk of molds forming is therefore higher.

It has also been observed that another parameter which can promote the formation of molds is the exposure time, that is, the amount of time during which the high values of relative humidity as above persist in the internal spaces.

Once the parameters that influence the formation, proliferation and growth of molds were known, systems were developed in the state of the art to prevent them. For example, US document US-A1-2006/0234382 describes a system that integrates an algorithm to determine whether the temperature and humidity values detected are indicative of conditions that promote or discourage the formation of molds.

One disadvantage of the system described by this prior art document is that it is mainly predictive. Furthermore, this solution does not allow to detect in an appropriate manner the values of temperature and humidity, so that the result obtained from the processing could not be able to efficiently asses if it is necessary, or not, to modify the environmental conditions to lower the risk of mold formation and growth.

Document US-A-2010/0305761 discloses an apparatus for the automatic control of an environment.

One purpose of the present invention is therefore to provide a method to control a conditioning apparatus that allows to prevent, or at least significantly limit, the formation of molds, reducing the risk of molds forming and growing in the rooms to be conditioned by the apparatus.

One purpose of the present invention is to provide a control method thanks to which a conditioning apparatus can activate automatically under determinate environmental conditions.

Another purpose of the present invention is to provide a method to control a conditioning apparatus which allows to repeatedly perform functioning cycles for a predefined time when determinate environmental conditions occur.

Another purpose of the present invention is to provide a control method which allows to identify zones of the room to be conditioned in which there is a high likelihood or risk that mold will form, proliferate and grow, and to command as a consequence the conditioning apparatus to direct a flow of air exiting from the apparatus selectively toward the zones identified.

Another purpose is to provide a conditioning apparatus in which a control method according to the present invention is implemented.

Another purpose of the present invention is to provide a conditioning apparatus able to autonomously recognize the presence of environmental conditions which promote the formation of molds, so as to be activated—for at least one functioning cycle having a predetermined duration—when such conditions occur

The Applicant has devised, tested and embodied the present invention to overcome the shortcomings of the state of the art and to obtain these and other purposes and advantages.

### SUMMARY OF THE INVENTION

The present invention is set forth and characterized in the independent claims. The dependent claims describe other characteristics of the present invention or variants to the main inventive idea.

In accordance with the above purposes, a method is provided to control a conditioning apparatus to prevent or reduce the risk/likelihood that molds will form, proliferate and grow in the room to be conditioned.

The method according to the present invention provides that the conditioning apparatus receives information that is characteristic of the room to be conditioned relating at least to the thermal state of the room itself.

In some embodiments, the conditioning apparatus detects or directly derives this characteristic information by means of sensor means that can be integrated in the conditioning apparatus.

In some embodiments, the method provides that the conditioning apparatus detects or derives this characteristic information repeatedly and periodically for a predefined monitoring period.

According to some embodiments, during the monitoring period the method provides that the sensor means perform a plurality of successive detections of temperature and relative humidity.

According to other embodiments, at the end of the monitoring period, the method provides to average the detected values of temperature and relative humidity in order to obtain a respective average value of temperature and relative humidity.

In some embodiments, the sensor means comprise temperature and humidity sensors of the type known in the state of the art.

In another embodiment, the conditioning apparatus receives the characteristic information as above from the outside, for example from remotely located sensor means which are not integrated in the apparatus, but rather are mounted on a third device for a remote control or on a control panel, for example mounted on one of the walls of the dwelling. According to some embodiments, the third device can be for example a smartphone.

In some embodiments, the information that is characteristic of the room to be conditioned comprises at least one of either the following parameters: internal temperature of the room to be conditioned detected at one or more detection points, external environmental temperature, atmospheric pressure, relative humidity of the room to be conditioned, external humidity, degree of thermal insulation of the room to be conditioned, energy efficiency index for the room to be conditioned, volume of the room to be conditioned, mode of use of the room to be conditioned, geographical exposure of the room to be conditioned with respect to the cardinal points, intended use of the room to be conditioned, building materials used for the construction of the walls of room to be conditioned, climatic conditions (for example sunny/rainy/foggy weather), weather forecasts.

The method according to the invention provides to calculate a risk factor indicative of the likelihood of mold formation which is a function of the characteristic information as above.

In some embodiments, the risk factor is calculated according to calculation algorithms known in the state of the art.

In some embodiments, the algorithms known in the state of the art comprise different predictive models of the growth of the molds, such as, by way of a non-limiting example: the VTT model, the Clarke & Rowan model, the Hens isopleth curves model, the Sedlbauer isopleth curves system, the bio-hygrothermal model.

In one embodiment, the risk factor is identified by a combination of the relative humidity inside the room to be conditioned and the exposure time during which the relative humidity persists.

In another embodiment, the risk factor is obtained as a ratio between the differences between the minimum surface temperature of an internal wall and the external temperature, with respect to the difference between the internal temperature and the external temperature.

Once the risk factor is known, the method according to the invention provides to compare it with a respective threshold value and to activate the conditioning apparatus for a determinate interval of time when the outcome of the step of comparing the risk factor with the respective threshold value reveals a high risk of mold formation.

In some embodiments, the method according to the invention provides to activate the conditioning apparatus when the outcome of the step of comparing the risk factor with the respective threshold value has revealed a high risk of mold formation at least for a minimum period of time within a reference time frame.

In some embodiments, the conditioning apparatus is activated when the comparison between the risk factor and the threshold value has revealed a high risk of mold formation for example at least for one hour, or for two hours, within a reference time frame of twelve hours.

In some embodiments, the threshold value is determined as a function of the characteristic information as above of the room to be conditioned.

In one embodiment, the threshold value can be defined by a relative humidity level present inside the room to be conditioned equal to 70% for an exposure time of two hours over the course of a twelve-hour period, or by a relative humidity level present inside the room to be conditioned equal to 90% for an exposure time of one hour over the course of a twelve-hour period.

In some embodiments, the method according to the invention provides to drive deflector means comprised in the conditioning apparatus at least during the monitoring period as above, in order to mix in a homogeneous manner the air in the room to be conditioned at least during the detection of the characteristic information by the sensor means as above.

The air inside a room, particularly when there is nobody inside it, tends to become still and stop, thus the values detected by the sensor means could be also very different from the average values inside the room, with the risk of obtaining an incorrect computation of the risk factor.

Thanks to the mixing of the air before and/or during the monitoring period it is possible to obtain a homogeneous distribution of the air, thus allowing a particularly effective detection by the sensor means.

In some embodiments, the method according to the invention provides a thermal scanning step of the room to be conditioned before activating the conditioning apparatus.

In one embodiment, the thermal scanning step can be implemented by means of suitable sensor means, for example optical or thermal sensors, or a combination thereof. In particular, the sensor means can comprise infrared sensors. The thermal scanning step allows to identify zones, or walls, of the room to be conditioned that have a reduced temperature.

In some embodiments, after the thermal scanning step as above, the method according to the invention provides to drive deflector means comprised in the conditioning apparatus to direct a flow of air arriving from the apparatus toward the zones, or walls, with a reduced temperature which have been previously identified.

According to the invention, a conditioning apparatus is also provided which implements the control method as above.

The conditioning apparatus object of the present invention can be, by way of example, a fan, or an air conditioner, for example of the domestic type, both portable and also attached to the walls of the room to be conditioned.

### BRIEF DESCRIPTION OF THE DRAWINGS

These and other characteristics of the present invention will become apparent from the following description of some embodiments, given as a non-restrictive example with reference to the attached drawings wherein:

FIG. 1 is a schematic view of an apparatus in which the method according to the present invention can be implemented;

FIG. 2 is a schematic perspective view of a room to be conditioned in which a conditioning apparatus is disposed which implements a method according to the present invention;

FIG. 3 is a graph which shows some characteristic curves of relative humidity as a function of the internal temperature of the room to be conditioned.

To facilitate comprehension, the same reference numbers have been used, where possible, to identify identical common elements in the drawings. It is understood that elements and characteristics of one embodiment can conveniently be incorporated into other embodiments without further clarifications.

### DETAILED DESCRIPTION OF SOME EMBODIMENTS

Embodiments described here concern a method to control a conditioning apparatus, which is indicated as a whole with reference number 10 and is visible in FIG. 2, in which it is disposed inside a room to be conditioned 50.

According to some embodiments, the conditioning apparatus 10 can be, by way of example, an air conditioner, for example of the domestic type, and suitable to generate a flow of air toward a room to be conditioned 50.

The conditioning apparatus 10 can be of a type suitable both to heat a room, typically when the environmental temperatures are low, and to cool a room, in particular when the environmental temperatures are high, and also to dehumidify a room, in particular when the relative humidity is high.

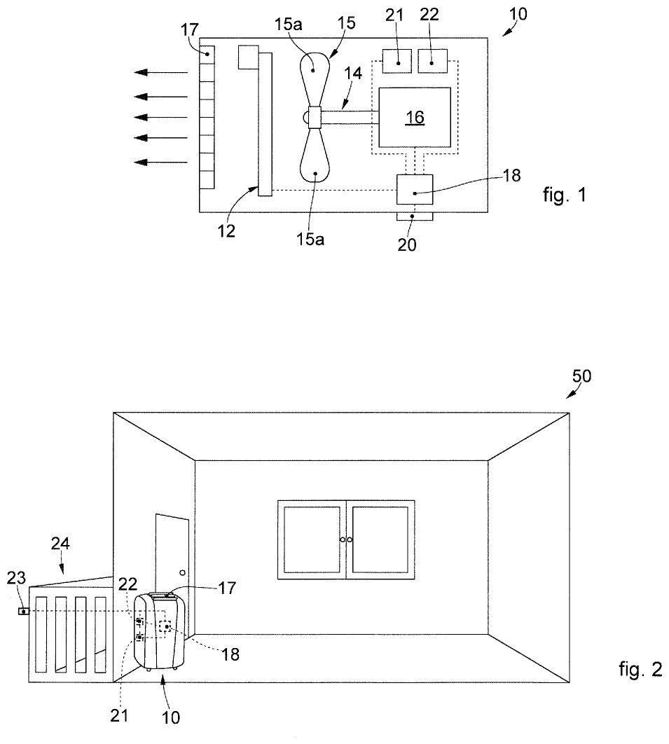

The conditioning apparatus 10, schematically shown in FIG. 1, comprises at least one conditioning device 12, able to heat or cool the air, and a ventilation device 14 suitable to generate a flow of air toward the conditioning device 12 in order to direct the heated or cooled air toward the room to be conditioned 50.

According to some embodiments, the conditioning device 12 is of a type known in the state of the art and can comprise a heating element of the resistive type and/or a cooling module.

According to further embodiments, the ventilation device 14 comprises a ventilator, or a fan 15 provided with a plurality of blades 15a and connected to a motor member 16 suitable to make the fan 15 rotate at the desired speed.

According to some embodiments, the fan 15 can be of the speed adjustable type and different speeds and mode of use can be provided, for example low, medium, high or even others.

In one embodiment, the flow of air exits the apparatus through an exit in which deflector means 17 are disposed, and which can be oriented so as to direct the flow of air in a preferred direction.

In one embodiment, the deflector means 17 comprise a plurality of fins which can be oriented.

According to some embodiments, the conditioning apparatus 10 comprises a control and command unit 18, connected at least to the conditioning device 12 and to the ventilation device 14 and configured to command the functioning thereof.

In some embodiments, the conditioning apparatus 10 comprises temperature sensor means 21, such as for example an analog or digital thermometer provided with a thermosensitive element known in the state of the art.

In some embodiments, the conditioning apparatus 10 comprises humidity sensor means 22, for example a hygrometer of a type known in the state of the art.

According to some embodiments, the temperature sensor means 21 and the humidity sensor means 22 can be both integrated on board the conditioning apparatus 10, and also disposed on a third device, separate and distant from the apparatus.

According to some embodiments, other temperature sensor means 23 are provided which are located remote from the conditioning apparatus. For example, as shown in FIG. 2, the other temperature sensor means 23 are disposed on a balcony 24 adjacent to the room to be conditioned 50.

In some embodiments, the sensor means 21, 22 and 23 are all operationally connected to the control and command unit 18.

In a preferred embodiment, the other temperature sensor means 23 are connected to the control and command unit 18 in wireless mode.

According to some embodiments, the conditioning apparatus 10 comprises a user interface 20 by means of which a user can turn the conditioning apparatus 10 on or off, and can possibly set its functioning parameters.

According to some embodiments, the user interface 20 is operationally connected to the control and command unit 18 and communicates with it in order to transfer the settings selected by the user to it.

The user interface 20 can comprise buttons or knobs that allow the user to set the functioning modes of the conditioning apparatus 10.

In one embodiment, by means of the user interface 20, the user can set the conditioning apparatus 10 so that it operates according to the control method of the present invention.

In one embodiment, the user interface 20 can be integrated into a portable remote control.

In another embodiment, the user interface 20 can be configured as an application for mobile devices, such as smartphones, or tablets.

The control method according to the invention provides to receive the characteristic information of the room to be conditioned and, on the basis of this information, calculate a risk factor indicative of the likelihood that molds will form.

Subsequently, the method provides to compare the risk factor with a threshold value.

The risk factor can be calculated according to many different algorithms known in the state of the art based on different predictive models of the growth of molds.

The characteristic information of the room to be conditioned 50 that has to be sent to apparatus 10 comprises parameters that are correlated to the algorithm chosen for the calculation of the risk factor. Naturally, the threshold value is also chosen as a function of the algorithm that is being used.

By way of a non-limiting example, we will now describe some modes for calculating the risk factor, indicating the respective threshold values for each of them.

A first example of calculation of the risk factor is based on the criterion of the ratio between temperatures.

In particular, this criterion provides to:
calculate a first difference between the minimum surface temperature of an internal wall and the external environmental temperature,
calculate a second difference between the temperature of the air inside the room to be conditioned and the external environmental temperature,
calculate the ratio between the first difference and the second difference; the result of this ratio being comprised between 0 and 1.

The value resulting from this ratio is indicative of the risk of mold formation and passes from a high risk in proximity to the value 0 to a minimum risk in proximity to the value 1.

In this example, the threshold value with which the result of the ratio as above has to be compared is approximately 0.65 and the conditioning apparatus 10 is activated if the result of the ratio (that is, the risk factor calculated) is lower than 0.65.

A second example of calculation of the risk factor is based on the relative humidity criterion.

In this case, the hygrometer 22 comprised in the conditioning apparatus 10 detects the relative humidity of the room to be conditioned 50.

This value detected is compared with a threshold value, which in this case can be equal to a relative humidity of 70% or 90%.

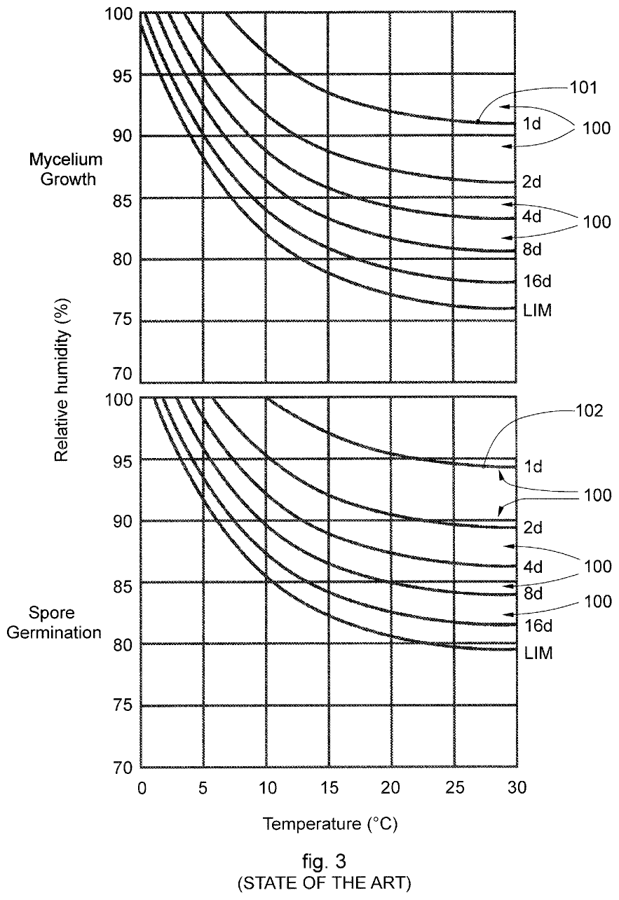

In a third example, it is possible to derive the risk factor from graphs known in the literature, such as for example the one shown in FIG. 3, where isopleth curves 100 are visible determined by means of experimental measurements of the germination of spores, and of the growth of the mycelium, for some species of mold on a determinate substrate. Each curve 100 collects the combinations of temperature and relative humidity values beyond which, relative to a certain time interval (expressed in days), the germination of spores/mycelium growth begin to occur. In other words, each curve 100 represents the “locus of points” defining the set of threshold values for which—after the time corresponding to that particular curve has elapsed—the germination or growth of the mycelium begins to occur.

The curve indicated with reference number 101 indicates the fact that, by way of example, at a temperature of 20° C., with a relative humidity of about 92%, after 1 day the growth of the mycelium begins to occur, which happens in a multitude of conditions, for example even at a temperature of about 12.5° C., with a relative humidity of 95%.

Similarly, the curve indicated with reference number 102 indicates the fact that, by way of example, at a temperature of about 22.5° C., with a relative humidity of 95%, after 1 day germination of spores begins to occur, which happens in a multitude of conditions, for example even at a temperature of 15° C., with a relative humidity of about 97%.

The curve indicated by the expression LIM, indicates the limit curves, below which a region of the graphs is identified where a plurality of combinations of temperature and relative humidity fall, in correspondence with which there is no growth of the mycelium, nor germination of spores.

In other examples, it is possible to use more complex algorithms to assess the risk factor, which can take into consideration many other factors able to affect the thermal state of the room.

By way of a non-exhaustive example, among the different parameters that can be taken into account to calculate the risk factor the following can be provided:
external climatic conditions (for example atmospheric pressure, external humidity),
the degree of thermal insulation of the room to be conditioned 50,
the energy efficiency index for the room to be conditioned 50,
the volume of the room to be conditioned 50,
the geographical exposure of the room to be conditioned 50 with respect to the cardinal points (north, south, east, west),
the position of the conditioning apparatus 10 in the room to be conditioned 50 (near the walls, in the center of the room, . . . ),
the intended use of the room to be conditioned 50 (kitchen, living room, bedroom, laundry room, . . . ),
the type of building materials used for the construction of the walls of the room to be conditioned (biodegradable, non-biodegradable, etc.).

In some embodiments, the parameters listed above are introduced into the conditioning apparatus 10 by the user, for example by means of the user interface 20.

According to further embodiments, one or more of the parameters listed above can be directly detected and/or estimated by means of some instruments and/or sensors.

As an example, the volume of the room to be conditioned 50 can be measured by infrared scanning technology. The position of the conditioning apparatus 10 can also be estimated on the basis of infrared sensors.

In some embodiments, some of the parameters listed above, such as for example the external climatic conditions (whether current or in the form of forecasts for the following days), can be communicated to the control and management unit 18 from the outside.

The method according to the invention therefore provides that the conditioning apparatus 10 is activated for a determinate interval of time when the comparison between the calculated risk factor and the threshold value reveals a high risk of mold formation, for example as explained with reference to the three examples described above.

In some embodiments, the method according to the invention provides to activate the conditioning apparatus 10 when the outcome of the step of comparing the risk factor with the respective threshold value has revealed a high risk of mold formation at least for a minimum period of time within a reference time frame.

For example, in some embodiments, the conditioning apparatus 10 is activated when the comparison between the risk factor and the threshold value has revealed a high risk of mold formation at least for one hour or for two hours within a reference time frame of twelve hours.

According to some embodiments, the activation of the conditioning apparatus 10 can comprise the activation of at least one between the heating element of the conditioning device 12, and the fan 15.

According to some embodiments, the activation of the conditioning apparatus 10 can comprise the activation of the heating element of the conditioning device 12, and the activation of the fan 15, so as to emit hot air toward the room to be conditioned 50.

According to some embodiments, the speed of the fan 15 can be adjusted as a function of the difference between the calculated/measured risk factor and the threshold value.

As an example, if the difference between the risk factor and the threshold value is greater than a determinate value, that is an high risk of mold formation has been detected, the fan 15 can be activated at maximum speed, while if the difference between the risk factor and the threshold value is lower than that determinate value, the fan 15 can be activated at minimum speed.

In this way, on the one hand, it is possible to obtain quickly a reduction of the risk of mold formation when it is particularly high, and on the other it is possible to reduce the overall energy consumption.

As an example, in the case of the risk factor calculated as the ratio between the temperatures, if the value is between 0.60 and 0.65 it could be provided to activate the fan 15 at lower speed, for example, in low or medium mode, while if the value is lower than 0.6, or possibly lower than 0.55, the fan 15 can be activated at maximum speed.

In some embodiments, the determinate time interval as above for which the conditioning apparatus 10 remains active is a function of the characteristic conditions as above.

In one embodiment, the conditioning apparatus 10 remains active for the time necessary to ensure that the risk factor is lowered so that the outcome of the subsequent comparison with the threshold value no longer indicates a high risk of mold formation.

In some embodiments, the control and command unit 18 can modify the time interval during which the conditioning apparatus 10 remains active, for example extending it when particular conditions occur. In particular, this can happen on the basis of meteorological information received by the control and command unit 18, for example when several consecutive days of rain are forecast in which the humidity will certainly be very high. Again, this can happen if molds are detected in the room to be conditioned, for example by means of optical sensors or directly by a user, and this information is communicated to the control and command unit 18 which extends the time interval during which the apparatus remains active.

According to some embodiments, when the outcome of the comparison between the risk factor and the threshold value reveals a minimum, or null risk of mold formation, the method provides to deactivate and/or put in stand-by the conditioning apparatus 10.

Thanks to the control method and to the conditioning apparatus 10 which implements it, the present invention provides a solution that allows to automatically activate the apparatus in order to prevent or limit the formation and growth of molds. This is particularly useful when a user is absent for a prolonged period of time, even weeks or months, during which the conditioning apparatus 10 can still be activated for the time necessary, for example also daily, to keep the risk of mold formation low thanks to the control of the relative humidity inside the room to be conditioned 50, operating at the same time only for an optimal interval of time, without the need to be always active.

It is clear that modifications and/or additions of steps may be made to the method to control a conditioning apparatus, and to the conditioning apparatus 10 as described heretofore, without departing from the field and scope of the present invention.

It is also clear that, although the present invention has been described with reference to some specific examples, a person of skill in the art shall certainly be able to achieve many other equivalent forms of a method to control a conditioning apparatus and of a conditioning apparatus 10, having the characteristics as set forth in the claims and hence all coming within the field of protection defined thereby.

1. A method to control a conditioning apparatus (10) to prevent or reduce the risk or likelihood that molds will form, proliferate and grow, in particular in internal spaces conditioned by said conditioning apparatus (10), comprising the steps of:
receiving information that is characteristic of a room to be conditioned (50) indicative of the thermal state of said room to be conditioned (50),
calculating a risk factor indicative of the likelihood of mold formation in said room to be conditioned (50), in which said risk factor is a function of said characteristic information,
comparing said risk factor with a respective threshold value,
said method being wherein it provides a step of activating said conditioning apparatus (10) for a determinate interval of time when the outcome of the step of comparing said risk factor with said respective threshold value reveals a high risk of mold formation.

2. The method as in claim 1, wherein it provides to activate said conditioning apparatus (10) when the outcome of said step of comparing the risk factor with said respective threshold value has revealed a high risk of mold formation at least for a minimum period of time within a reference time frame.

3. The method as in claim 1, wherein said step of receiving the characteristic information of a room to be conditioned (50) provides to detect at least one temperature value and at least one relative humidity value by means of respective sensor means (21, 22, 23) comprised in said conditioning apparatus for a predefined monitoring period.

4. The method as in claim 3, wherein said predefined monitoring period is repeated cyclically at regular time intervals, for example every sixty minutes.

5. The method as in claim 3 wherein during said predefined monitoring period a plurality of successive measurements of temperature and relative humidity are made by said sensor means (21, 22), and in that, at the end of said monitoring period, it provides to average the detected values of temperature and relative humidity in order to obtain a respective average value of temperature and relative humidity.

6. The method as in claim 1, wherein during said step of receiving the characteristic information of a room to be conditioned (50) it provides to drive in an alternate movement deflector means (17) comprised in said conditioning apparatus (10) so as to mix the air in the room to be conditioned (50).

7. The method as in claim 1, wherein before said step of activating said conditioning apparatus (10), it provides a thermal scanning step of the room to be conditioned (50) by suitable sensor means comprised in said conditioning apparatus (10), and in that after said thermal scanning step of the room to be conditioned, it provides to drive deflector means (17) comprised in said conditioning apparatus (10), to direct a flow of air arriving from said apparatus toward one or more zones with a reduced temperature that have been identified in said thermal scanning step.

8. The method as in claim 1, wherein said step of activating said conditioning apparatus (10) comprises at least one between the activation of a heating element of the conditioning device (12), and the activation of a fan (15).

9. The method as in claim 8, wherein it provides to adjust the speed of said fan (15) as a function of the difference between said risk factor and said threshold limit.

10. The method as in claim 1, wherein said characteristic information of a room to be conditioned (50) comprises one or more parameters selected from a group consisting of:
temperature inside the room to be conditioned,
external environmental temperature,
relative humidity of the room to be conditioned (50),
external humidity,
atmospheric pressure,
degree of thermal insulation of the room to be conditioned (50),
energy efficiency index for the room to be conditioned (50),
volume of the room to be conditioned (50),
position of said conditioning apparatus in said room to be conditioned (50),
geographical exposure of said room to be conditioned (50) with respect to the cardinal points,
intended use of the room to be conditioned (50),
building materials used for the construction of the walls of said room to be conditioned (50).

11. The method as in claim 10, wherein said external environmental temperature can be detected by temperature sensor means (23) located remote from the room to be conditioned (50) and operationally connected to said conditioning apparatus (10) and/or can be an external environmental temperature estimated or predicted by independent meteorological forecasting units, operationally connected to said conditional apparatus (10).

12. The method as in claim 10, wherein when the outcome of the comparison of the risk factor with the threshold value reveals a minimum, or null risk of mold formation, it provides to deactivate and/or put in stand-by the conditioning apparatus (10).

13. An apparatus to condition a room, wherein it comprises a control and management unit (18) which implements a control method as in any claim hereinbefore, and in that it also comprises:
temperature and relative humidity sensor means (21, 22) operationally connected to the apparatus, which can be integrated directly into the apparatus or disposed on a separate device distant from the apparatus,
conditioning means (12) able to heat or cool the air,
ventilation means (14) configured to generate a flow of air toward said conditioning means (12),
motor means (16) to drive said ventilation device (14).
